(19) United States
(12) Patent Application Publication
(10) Pub. No.: US 2006/0136979 A1
(43) Pub. Date: Jun. 22, 2006

(54) Apparatus and methods for encoding data for video compositing

(76) Inventors: Allan Robert Staker, El Segundo, CA (US); Heather Clayton Staker, El Segundo, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/266,769

(22) Filed: Nov. 3, 2005

Related U.S. Application Data
(60) Provisional application No. 60/630,831, filed on Nov. 4, 2004.

(51) Int. Cl. H04N 7/173; H04N 7/16

(52) U.S. Cl. 725/134; 725/142; 725/89

(57) ABSTRACT

A storage medium, such as a digital versatile disc (DVD), that includes both a media and a data portion. The media portion comprises, for example, one or more scenes movie, a television program or the like. In certain embodiments, the media portion s a full-length movie. The data portion includes reference information, such as data able by a compositing device to selectively insert a real-time image into a video scene on the media portion. For example, the data files may contain a plurality of trigger that provides for the display, at appropriate times, of a real-time composite image of the prerecorded video scene.

### RELATED APPLICATION

This application claims the benefit of priority under 35 U.S.C. § 119(e) of U.S. Provisional Application No. 60/630,831, filed on Nov. 4, 2004, and entitled “METHODS AND APPARATUSES FOR ENCODING DATA FOR VIDEO COMPOSITING,” the entirety of which is hereby incorporated herein by reference and is to be considered as part of this specification.

### BACKGROUND OF THE INVENTION

1. Field of the Invention

Embodiments of the invention described herein relate generally to video compositing and, in particular, to apparatus and methods for encoding data for video compositing.

2. Description of the Related Art

Interactive entertainment is a popular leisure activity for people across the globe. One favorite activity for many is karaoke, which temporarily turns lay persons into “stars” as they sing the lyrics to a favorite song. Karaoke machines play the music of a selected song while simultaneously displaying the song lyrics to a user.

Another favorite leisure activity for millions is watching movies. Billions of dollars are spent each year on movie purchases and rentals for home use. A substantial amount of these sales is for movies recorded on a digital video disc or a digital versatile disc (DVD). Home movie watching, however, has predominantly been a passive activity, wherein there is little if any viewer interaction. Furthermore, although one may watch the same movie repeatedly, each time the same characters appear and recite the same lines and perform the same actions.

To address the foregoing drawback, DVDs have been developed that contain multiple tracks that offer a variety of functions. For example, a standard DVD may hold over two hours of high-quality digital video, support for widescreen viewing, tracks for digital audio (for multiple languages, commentaries, and the like), subtitle tracks, automatic seamless branching of video (for multiple story lines or ratings on one disc), camera angles, on-screen menus and simple interactive features (for games, quizzes, and the like). Certain DVDs are also designed to store and execute software applications on personal computers.

### SUMMARY OF THE INVENTION

Certain embodiments of the invention provide a user with apparatus and methods for selectively inserting a real-time image of the user into a prerecorded video scene. Furthermore, embodiments of the invention provide a storage media that includes both prerecorded media, such as scenes from a movie, and reference data usable to direct the insertion of the user image into a selected video scene. In certain embodiments, the prerecorded media and the reference data are recorded on a single DVD that is usable with a real-time video compositing device.

In certain embodiments, a storage medium is disclosed for use in interactive video compositing. The storage medium comprises a first portion including media data usable to produce at least one video image having multiple frames. The storage medium also comprises a second portion including reference data associated with the media data. The reference data further comprises first video reference data and second video reference data. The first video reference data identifies a first frame of the at least one video image to be combined with a second video image to form a composite video image to be communicated to a display. The second video reference data identifies a second frame of the at least one video image to be communicated to the display. In certain embodiments, the storage medium comprises a removable memory, such as, for example, a DVD.

In certain embodiments, a method for video compositing is disclosed. The method includes receiving from a prerecorded medium a first video signal having multiple frames and also receiving a second video signal. The method further includes creating a composite signal by mixing the first video signal and the second video signal and selectively switching between outputting the first video signal and outputting the composite signal. For instance, the selective switching may be performed automatically and be based at least in part on reference data, stored on the prerecorded medium, that corresponds to frames of the first video signal.

In certain embodiments, a system for real-time video compositing is disclosed. The system comprises a reader, a video input, a mixing module and a switching module. The reader is configured to obtain from a storage medium a first video signal and at least one data file associated with the first video signal, the at least one data file having at least first reference data and second reference data. The video input is configured to receive a second video signal. The mixing module is coupled to the reader and to the video input and is configured to output a composite signal comprising portions of the first video signal and portions of the second video signal. The switching module selects between outputting the composite signal and outputting the first video signal, wherein the switching module outputs the composite signal at a time identified by the first reference data and outputs the first video signal at a time identified by the second reference data. In certain embodiments, the storage medium comprises a removable memory, such as, for example, a DVD.

In certain embodiments, an electronic system is disclosed for performing video compositing. The electronic system comprises means for receiving from a single storage medium a first video signal and at least one data file associated with the first video signal, the at least one data file including first reference data and second reference data. The electronic system also comprises means for receiving a second real-time video signal and means outputting a composite signal comprising portions of the first video signal and portions of the second real-time video signal. The electronic system further comprises means for selectively switching between outputting the composite signal and outputting the first video signal, wherein the means for selectively switching outputs the composite signal at a time identified by the first reference data and outputs the first video signal at a time identified by the second reference data. In certain embodiments, the single storage medium comprises a DVD.

For purposes of summarizing the invention, certain aspects, advantages and novel features of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

FIG. 1 illustrates a schematic view of a DVD having media and data files stored thereon according to certain embodiments of the invention.

FIG. 2 illustrates a block diagram representation of an exemplary data file structure usable with the DVD of FIG. 1.

FIG. 3 illustrates a block diagram of an exemplary embodiment of a real-time video compositing system usable to play the DVD of FIG. 1.

FIG. 4 illustrates a block diagram of an exemplary embodiment of a compositor device usable with the compositing system of FIG. 3.

FIG. 5 illustrates an exemplary embodiment of a user interface usable with the compositor device of FIG. 4.

FIG. 6 illustrates a block diagram of an exemplary embodiment of another compositor device usable with the compositing system of FIG. 3.

FIG. 7 illustrates a flow chart depicting an interactive video compositing process according to certain embodiments of the invention.

FIG. 8 illustrates a flowchart depicting an exemplary embodiment of a method usable for performing video compositing.

### DETAILED DESCRIPTION OF THE PREFERRED EMBODIMENTS

Some preferred embodiments of the invention described herein relate generally to video compositing and, in particular, to apparatus and methods for encoding data used for video compositing. While the description sets forth various embodiment-specific details, it will be appreciated that the description is illustrative only and should not be construed in any way as limiting the invention. Furthermore, various applications of the invention, and modifications thereto, which may occur to those who are skilled in the art, are also encompassed by the general concepts described herein.

In addition, methods and functions described herein are not limited to any particular sequence, and the acts or blocks relating thereto can be performed in other sequences that are appropriate. For example, described acts or blocks may be performed in an order other than that specifically disclosed, or multiple acts or blocks may be combined in a single act or block.

The term “compositing” as used herein is a broad term and is used in its ordinary sense and includes without limitation the superimposing or combining of multiple signals, such as, for example, video and/or audio signals, to form a composite signal. The term “compositor” refers to any device or system, implemented in hardware, software, or firmware, or any combination thereof, that performs a compositing function.

The term “chroma-key” as used herein is a broad term and is used in its ordinary sense and describes without limitation a system, device, or process that is used to create an effect wherein at least one color or hue in a video image is eliminated or substituted with a different image. For example, a chroma-key technique, also referred to as color separation overlay, may utilize a mixer or like device to substitute a color, such as blue or green, in one video image for select portions of another video image.

The term “real time” as used herein is a broad term and is used in its ordinary sense and includes without limitation a current state or period of time during which some event or response takes place. A real-time system or application produces a response to a particular stimulus within a certain response time. For example, a device processing data in real time may process the data as it is received by the device. A real-time signal is one that is capable of being displayed, played back, or processed within a particular time after being received or captured by a particular device or system. In one embodiment, this particular time is on the order of one millisecond. In other embodiments, the particular time may be longer than one millisecond, such as, for example, on the order of hundreds of milliseconds. In other embodiments of the invention, the particular time may be less than one millisecond, such as, for example, on the order of microseconds. In yet other embodiments of the invention, “real time” refers to events simulated at a speed similar to the speed at which the events would occur in real life.

The term “reference information” as used herein is a broad term and is used in its ordinary sense and includes without limitation any type, or combination of types, of data that stores or contains information regarding particular media. For example, reference information may comprise reference points that identify video scenes containing particular characters. However, reference information is not limited to such reference points. In other embodiments of the invention, reference information may comprise code, symbols, alphanumeric information, or the like that represent a song, a particular event, or a particular image that is contained or represented in particular media, such as an audiovisual signal or recording.

The term “movieoke” as used herein is a broad term and is used in its ordinary sense and refers without limitation to video compositing using prerecorded video content, such as, for example, video scenes stored on a DVD.

Apparatus and methods for encoding video compositing data will now be described with reference to the drawings summarized above. The drawings, associated descriptions, and specific implementation are provided to illustrate embodiments and do not limit the scope of the disclosure.

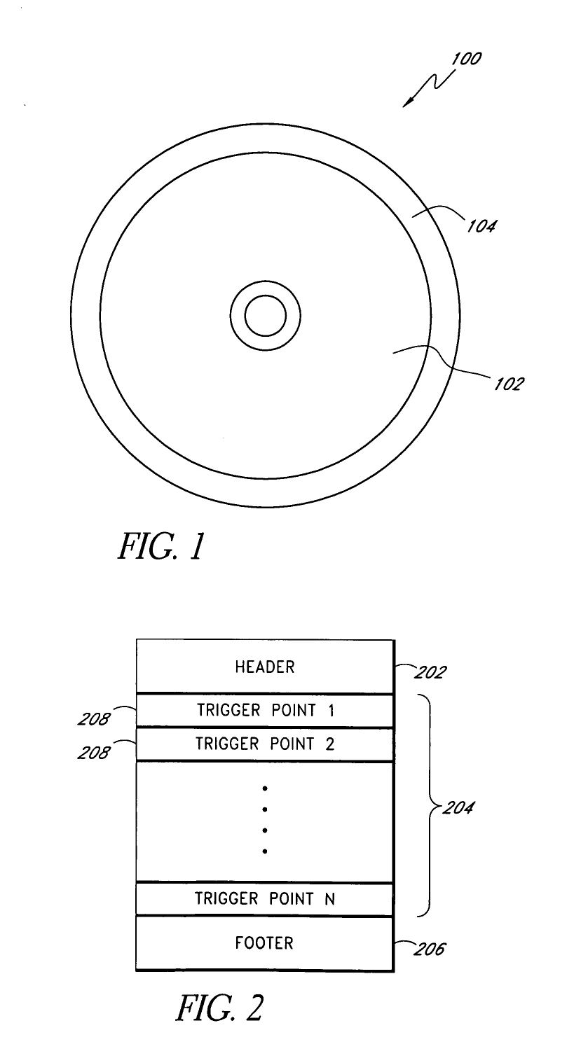

FIG. 1 illustrates a simplified schematic view of a DVD 100 having data files stored thereon, according to certain embodiments of the invention. In particular, the illustrated DVD 100 is a storage medium that includes a media portion 102 and a data portion 104. The media portion 102 includes, for example, one or more prerecorded scenes of filmed entertainment, such as a movie. For instance, the media portion 102 may include a movie that is recorded in MPEG 2 format and that is playable on standard DVD players.

In certain embodiments, the data portion 104 includes reference information or data files usable to “insert” or superimpose a real-time image and/or audio signal in a scene recorded on the media portion 102. For instance, in certain embodiments of the invention, and as described in more detail below, the reference information may include software code that identifies particular frames in which a real-time image and/or audio signal is to be inserted into a movie scene (e.g., during appearances of a particular movie character) and/or may include data relating to audio manipulation, closed captioning or subtitle use, color saturation, aspect ratio, combinations of the same or any other like feature used in video or audio manipulation.

In certain embodiments, the data portion 104 advantageously includes one or more tracks of code that may be used to control the video output of a video compositing system, such as a real-time video compositing system, that combines a prerecorded signal with a second signal, such as a real-time video and/or audio signal. Embodiments of video compositing systems usable with embodiments of the present invention are described in more detail below and are also disclosed in U.S. patent application Ser. No. 10/836,729, filed Apr. 30, 2004, and entitled “INTERACTIVE SYSTEM AND METHOD FOR VIDEO COMPOSITING,” which is hereby incorporated herein by reference and is to be considered a part of this specification.

In certain embodiments, when the DVD 100 is inserted into the compositing device, the DVD 100 coordinates the output of the compositing device in real time as the media is being played. Accordingly, the compositing device reads the data files in real time while simultaneously manipulating the playback of the stored media to create the composite, or “movieoke,” output signal.

For ease of reference, hybrid-type DVDs such as the DVD 100, which contain both prerecorded media and reference information, will be referred to hereinafter as “DVD+M” (DVD+Movieoke).

In certain embodiments, the media portion 102 and/or the data portion 104 include one or more tracks on the DVD+M 100. In other embodiments, other means for storing media files and/or reference information may be used. For instance, the data portion 104 may comprise one or more folders or executable files. In certain embodiments, the media portion 102 and the data portion 104 may be recorded on different sides and/or different layers of the DVD+M. In certain embodiments, the media portion 102 and the data portion 104 may be interleaved or interspersed on the DVD+M. In yet other embodiments, the data portion 104 may be included in, or may include, a bonus material section available with certain commercially available DVDs.

FIG. 2 illustrates a block diagram representation of an exemplary data file structure 200 usable with the DVD+M 100 illustrated in FIG. 1. For example, the file structure 200 may be at least partially stored in the data portion 104 of the DVD+M 100 of FIG. 1. In certain embodiments, the file structure 200 contains reference data for use in video compositing that corresponds to video and/or audio media stored on the media portion 102 of the DVD+M 100.

The illustrated file structure 200 includes a header 202, a body 204 and a footer 206. In certain embodiments, the header 202 includes information usable to reset a compositing device and/or to provide the compositing device with set-up information relating to a particular video scene or scenes. For example, the header 202 may identify the video scene or scenes stored on the video portion 102 to be used in a compositing playback process. The header 202 may also dictate a color saturation level, a brightness, a contrast, an aspect ratio of the prerecorded media, combinations of the same or the like. Such information regarding the video signal may be used by the compositing device to manipulate a second video signal, such as from a video camera signal, to substantially conform or blend in the second video signal with the prerecorded media during video compositing.

The illustrated body 204 comprises a plurality of trigger points 208. In certain embodiments, the trigger points 208 identify frames within the prerecorded media in which a second signal is to be inserted or superimposed. For example, the trigger points 208 may identify frames or time codes of the prerecorded media into which are to be inserted one or more video signals (e.g., a real-time signal from a video recorder), one or more audio signals (e.g., a real-time signal from a microphone), and/or closed captioning information. In other embodiments, the body 204 may comprise additional information usable to enhance the compositing process of a prerecorded signal with a real-time signal.

In certain embodiments, the footer 206 includes data usable to reset the compositing device playing the DVD+M. For example, the data in the footer 206 may return the compositing settings to their default modes after the user has finished “acting out” one or more scenes.

The following is an exemplary embodiment of a simplified file structure of a data file that may be encoded on a data portion of a DVD+M.

#TITLE: SAMPLE DVD+M SCRIPT FILE#
#HEADER#
LoadRIFF 1 E:\Video\ChuBBs4.avi
LoadRIFF 2 E:\Video\ChuBBs4.A1.wav
LoadRIFF 3 E:\Video\ChuBBs4.A2.wav
KeyMode 2
KeyChroma 0.0 0.0 92.7 0.77 0.24
KeyLuma 0.77 0.53 0.36 0.78 0.00
HideOverlay
#BODY#
Play
Wait 0.0 ShowOverlay
Wait 199.0 HideOverlay
Wait 415.0 ShowOverlay
Wait 521.0 HideOverlay
Wait 748.0 ShowOverlay
Wait 905.0 HideOverlay
Wait 999.0 ShowOverlay
Wait 1134.0 HideOverlay
Halt
#FOOTER#
KeyMode 2
KeyChroma 0.0 0.0 92.7 0.77 0.24
KeyLuma 0.77 0.53 0.36 0.78 0.00
HideOverlay

As shown, the simplified file structure includes a title identifying the sample DVD+M script file. Following the title is a header, which includes data relating to the prerecorded video and audio to be used by a compositing device. For instance, the header includes display information (e.g., “KeyChroma” and “KeyLuma”) that identifies the color and brightness of the portions of the video scene to be overlaid.

The simplified file structure also includes a body having a plurality of video trigger points. In particular, the video trigger points identify, by time code, frames of the selected prerecorded video scene into which a real-time video image is to be inserted or superimposed. The time code is identified by a numeric value following a “Wait” command. The specific actions to be performed, such as inserting or removing the real-time video image, are identified by the commands “ShowOverlay” or “HideOverlay.”

Following the body is a footer portion that includes information usable to return the settings of a video compositing device to its default or other settings.

Although the above simplified file structure has been given by way of example, it is contemplated that file structures usable with embodiments of the invention may contain significantly more trigger points and/or other like information usable for video compositing. For example, other file structures may include trigger points for audio signals and/or closed captioning information.

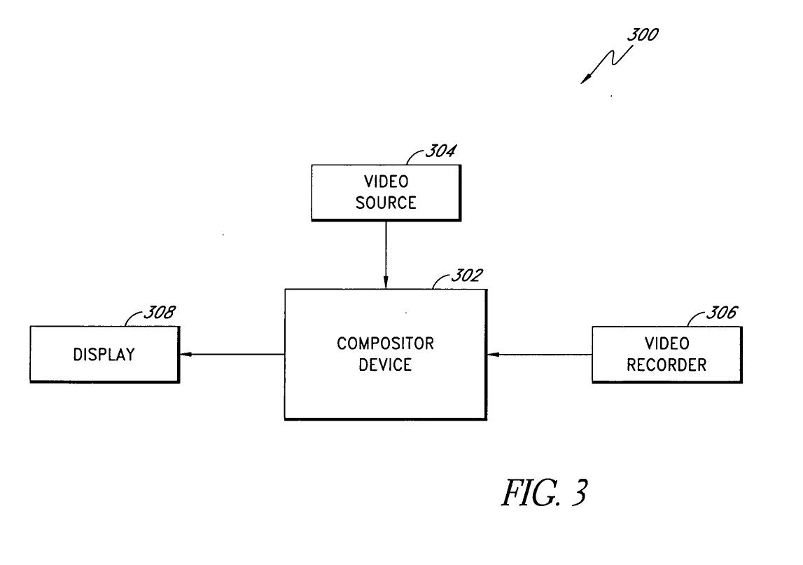

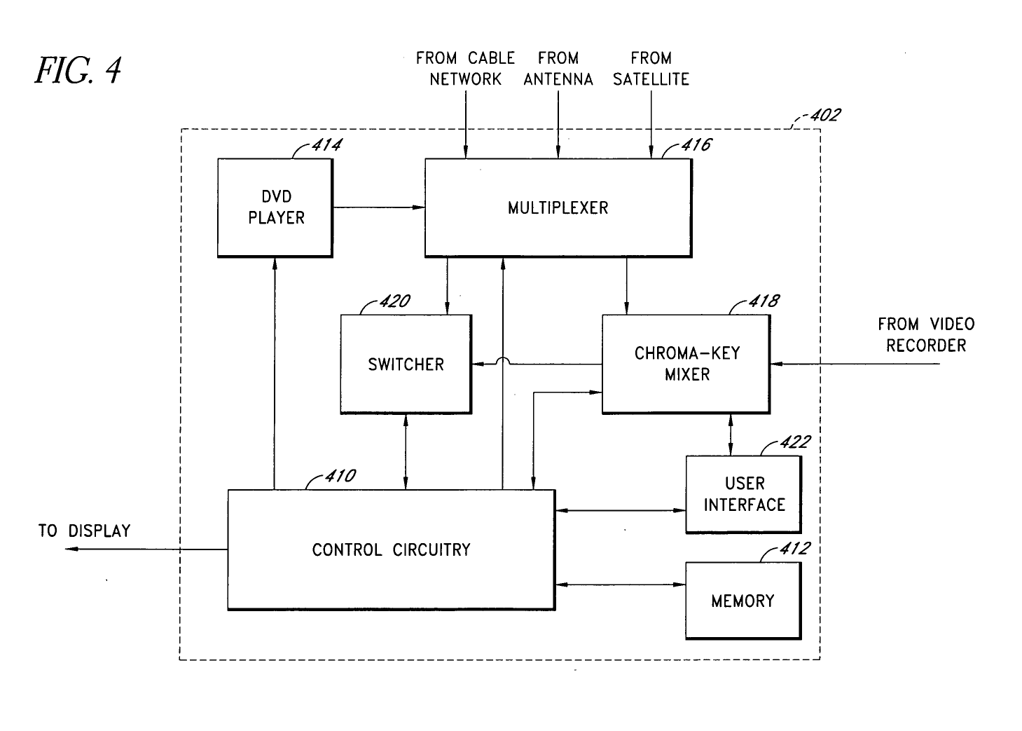

FIGS. 3-7 illustrate further details of exemplary embodiments of video compositing systems and methods usable with embodiments of the present invention. For instance, the video compositing systems described hereinafter may be used to read and process a DVD+M disc, such as the DVD+M 100 of FIG. 1.

FIG. 3 illustrates an embodiment of a real-time video compositing system 300 that is used to selectively superimpose signals, such as video and/or audio signals. In certain embodiments, these signals may comprise real-time images, prerecorded images, or a combination thereof. For example, the compositing system 300 may superimpose a real-time image onto a prerecorded image, such as from a movie scene.

As shown, the compositing system 300 generally comprises a compositor device 302, a video source 304, a video recorder 306 and a display 308. In certain embodiments, the compositor device 302 receives inputs signals from the video source 304 and the video recorder 306 and outputs a signal to the display 308.

The video source 304 includes any device, system or technology used to generate, receive, capture, read, supply and/or store video data. In certain embodiments, the video source 304 may generate an audiovisual signal having a video portion that can be processed to produce a video signal (e.g., to produce a visual image) and an audio portion that can be processed to produce an audio signal. For example, in certain embodiments of the invention, the video source 304 is configured to read a removable storage medium. For instance, the video source may comprise a DVD player. In other embodiments, the video source 304 comprises a memory that stores data representing video content. In yet other embodiments, the video source 304 may comprise a device that receives a video transmission, such as through a cable network, a satellite dish, an antenna, or a network. For example, the video source 304 may comprise a television, a video cassette recorder (VCR), a CD+G player, a digital video recorder, combinations of the same or the like.

In certain embodiments of the invention, the compositing system 300 may include multiple video sources 304, each being coupled to the compositor device 302. In such embodiments, the compositing system 300 may comprise a multiplexer or a switch that selects a signal from one of multiple video sources 304. For example, in one embodiment, the compositing system 300 comprises a DVD player and a cable box that receives a video transmission over a coaxial cable line. A two-input multiplexer may then be used to select between a signal from the DVD player and a signal from the cable box.

The video source 304 may be coupled to the compositor device 302 by any medium that provides for video signal transmission, such as, for example, through an RCA cable, an S-cable, a coaxial cable, Ethernet, wireless technologies or the like. The video source 304 may also supply audio content along with video content wherein the audio content is delivered on the same or a different medium as the video content.

FIG. 3 depicts the video source 304 as external to the compositor device 302. In other embodiments of the invention, the video source 304 may be internal to the compositor device 302. For example, the compositor device 302 may comprise a DVD player or may comprise a memory having stored video data. In yet other embodiments, the compositing system 300 may comprise at least one video source 304 that is internal and at least one video source 304 that is external to the compositor device 302. In yet other embodiments, the video source 304 may be removable from the compositor device 302.

With continued reference to FIG. 3, the compositing system 300 includes the video recorder 306, which comprises any device, system or technology that is capable of converting real-time video images into an electronic signal, such as a digital or an analog signal. In certain embodiments, the video recorder 306 comprises a video camera, such as an analog camcorder or a digital camcorder. The video recorder 306 may couple to the compositor device 302 through an RCA cable, an S-cable, a coaxial cable, Ethernet, wireless technologies or the like.

In other embodiments of the invention, the compositing system 300 may include multiple video recorders 306, each being coupled to the compositor device 302. In addition, one or more of the video recorders 306 may be internal or external to the compositor device 302.

The compositing system 300 also comprises the display 308, which receives an output signal from the compositor device 302 and converts the output signal to at least a video image. For example, in certain embodiments of the invention, the display 308 comprises a television. In other embodiments, the display 308 may include a video projector, a monitor or the like.

In certain embodiments of the invention, the display 308 may also be used to provide instructions or data to the user or users of the compositing system 300. For example, menu selections or command prompts may be displayed to the user through the display 308. In addition, dialogue prompts, such as used in karaoke, may be portrayed on the display 308 to assist a user in reciting the appropriate lines of a particular scene.

In other embodiments of the invention, the compositing system 300 may comprise multiple displays 308. The display 308 may also be internal or external to the compositor device 302. For example, the compositor device 302 may include a screen that portrays a video image to the user. Such a screen may allow a user to have visual feedback of the final output of the compositing system 300 without looking at an external display.

In certain embodiments, the compositing system 300 may also comprise a media storage device (not shown) that stores the signal output by the compositor device 302. For example, the compositor system 300 may comprise a memory configured to store in digital form a copy of the output signal that is sent to the display 308. In another embodiment, the compositing system 300 may output a signal only to the media storage device instead of the display 308. In such an embodiment, the output video and audio content could be stored for later playback on another device. In yet other embodiments, the media storage device may be included with the display 308.

FIG. 4 illustrates a block diagram of an exemplary embodiment of a compositor device 402. The compositor device 402 allows a user to selectively overlay images in real time onto a second video image, such as prerecorded video content. As shown, the compositor device 402 comprises control circuitry 410, a memory 412, a DVD player 414, a multiplexer 416, a chroma-key mixer 418, a switcher 420 and a user interface 422.

In certain embodiments, one or more components of the compositor device 402 are modules that comprise logic embodied in hardware or firmware, or that comprise collection of software instructions written in a programming language, such as, for example C++. A software module may be compiled and linked into an executable program, installed in a dynamic link library, or may be written in an interpretive language such as BASIC. Software modules may be callable from other modules or from themselves and/or may be invoked in response to detected events or interrupts. Software instructions may be embedded in firmware, such as an EPROM or EEPROM. Hardware modules may comprise connected logic units and/or programmable units, such as programmable gate arrays or processors. For example, in one embodiment, the functions of the compositor device 402 may be implemented in whole or in part by a personal computer or other like device.

The components of the compositor device 402 need not be integrated into a single device. The components can be separated into several subcomponents or can be separated into different devices that reside at different locations and that communicate with each other, such as through a wired or wireless network. Components described herein may also be integrated into a fewer number of modules.

The control circuitry 410 directs the operation of components of the compositor device 402. In certain embodiments, the control circuitry 410 is a special purpose microprocessor. In other embodiments, the control circuitry 410 may be implemented as an application-specific integrated circuit (ASIC). In yet other embodiments, the control circuitry 410 may be implemented as one or more modules, which modules may be configured to execute on one or more processors. The modules may comprise, but are not limited to, any of the following: hardware or software components such as software object-oriented software components, class components and task components, processes, methods, functions, attributes, procedures, subroutines, segments of program code, drivers, firmware, microcode, applications, algorithms, techniques, programs, circuitry, data, databases, data structures, tables, arrays, variables or the like.

The control circuitry 410 communicates with the memory 412. The memory 412 may comprise any buffer, computing device, or system capable of storing computer instructions and data for access by another computing device or a computer processor, such as, for example, the control circuitry 410. In certain embodiments, the memory may also store video data, such as, for example, scenes of a movie.

In certain embodiments, the memory 412 comprises random access memory (RAM). In other embodiments, the memory 412 may comprise other integrated and accessible memory devices, such as, for example, read-only memory (ROM), programmable ROM (PROM), and electrically erasable programmable ROM (EEPROM). In another embodiment, the memory 412 comprises an external hard drive or a removable memory, such as, for example, a floppy disk, a compact disc (CD), a ZIP( disk, a DVD, a removable drive or the like.

Although the memory 412 is depicted as being external to the control circuitry 410, in other embodiments of the invention, the memory 412 may be internal to the control circuitry 410. For example, the memory 412 may exist as a cache in the control circuitry 410.

The DVD player 414 is one embodiment of a video source usable with the compositor device 402. In certain embodiments, the DVD player 414 functions as a general purpose DVD player and outputs video and audio content stored on a DVD to the multiplexer 416. The DVD player 414 may also include a counter that identifies the current frame of the DVD. For example, the DVD counter may correlate each frame of the DVD with a specific time code relating to the media stored on the DVD. The DVD player 414 may also read DVD serial numbers to identify the media content contained by the particular DVD and may communicate the serial number to the control circuitry 410.

In certain embodiments, the DVD player 414 is configured to read DVDs, such as the DVD+M 100 of FIG. 1, that include both media and data content. For instance, in certain embodiments, the DVD player 414 reads from a portion of the DVD+M storing data files that include data or information regarding the content of particular media. In certain embodiments, such a file or group of related data files contains information specific to a movie or prerecorded video footage stored on the media portion of the DVD+M. For example, the information contained in the data files may identify scenes or segments of the movie or video that have been catalogued as being suitable for video compositing. The data files may also contain content relating to dialogue prompts for particular characters, menu options, and other data relating to scenes available for video compositing.

In certain embodiments, the data files contain reference information that identifies particular frames or points in the media portion of the DVD+M that may be used in the compositing process. For example, in certain embodiments, the reference information may be read by the DVD player 414 and used by the compositing device 402 to identify the frames of a movie scene in which a particular character is present. In certain embodiments, the reference information may contain both beginning and ending reference points, wherein the beginning reference point indicates the commencement of a particular feature in the video source, such as the entrance of a character into a scene, and wherein the ending reference point identifies the ending of a particular feature, such as when the character exits the scene.

For example, the data files on the DVD+M may contain information relating to the individual frames of a particular movie, such as Star Wars. In one embodiment, the preprogrammed data files associated with Star Wars identify scenes in the movie that have been selected as being suitable as a background for video compositing. The data files may identify when a particular character, such as Darth Vader®, is present in a specific scene. This data file information is read by the DVD player 414 and is processed by the control circuitry 410 to coordinate and create a composite video signal.

In other embodiments of the invention, the data files may be stored in the memory 412 in place of, or in addition to, being stored on the DVD+M. For example, the data files may be preprogrammed in the memory 412 or may be later saved in the memory 412 by the user. In other embodiments, the data files may be generated in real time, derived or received from an external source or device or generated by the compositor device 402. For example, data files for particular media may be downloaded from a network, such as the Internet, or transferred from an external storage medium. In yet other embodiments, the data files may be embedded in a closed-caption signal.

In embodiments wherein data files are stored in the memory 412, the data files may reference a particular movie by the movie's unique serial number. For example, when a Star Wars DVD is placed in the DVD player 414, the DVD player 414 communicates the DVD's serial number to the control circuitry 410. The control circuitry 410 then uses the serial number to find the appropriate data files stored in the memory 412. The data files identify the media content of the DVD as being the Star Wars movie and also identify which scenes, or frames, are to be played by the DVD player 414.

In one embodiment of the invention, the DVD player 414 also reads DVDs that contain only data. For example, in one embodiment, the DVD player 414 is used to read DVDs that contain data files that are associated with several movies or videos, which data files may be copied to the memory 412.

With continued reference to FIG. 4, other video sources, such as external video sources, may communicate with the compositor device 402. In certain embodiments, the multiplexer 416 is configured to accept signals from multiple external sources as well as from the DVD player 414. For example, the illustrated multiplexer 416 receives signals from the DVD player 414, a cable network, an antenna and a satellite. In other embodiments, the multiplexer 416 may be configured to receive fewer or more signals. For example, multiplexer 416 may be configured to receive a streaming video over a network or data from a cable box. The multiplexer 416 may also be configured to receive auxiliary signals from an external DVD player or a VCR.

The multiplexer 416 selects one of multiple input signals based on a control signal. In certain embodiments, the control circuitry 410 supplies the control signal to the multiplexer 416. In another embodiment, the multiplexer 416 automatically selects the signal from the DVD player 414 when a DVD is inserted therein and selects the signal from the other available signals when no DVD is present in the DVD player 414. For example, in one embodiment, the user may input a selection through the user interface 422.

As shown in FIG. 4, the multiplexer 416 outputs the selected signal to a mixing module and a switching module (i.e., the chroma-key mixer 418 and the switcher 420). In other embodiments of the invention, other switching devices or routers may be used in place of the multiplexer 416 to select between multiple input signals and to communicate the selected signal to other components.

The “chroma-key” mixer 418 receives signals from the multiplexer 416 and from a video recorder. The chroma-key mixer 418 processes these two input signals to output composite signal to the switcher 420. The chroma-key mixer 418 may also receive control signals from the control circuitry 410 and/or from the user interface 422.

In certain embodiments, the chroma-key mixer 418 creates special visual effects that utilize the combination of two video signals to produce one composite image. In particular, the chroma-key mixer 418 produces a composite image wherein it appears that the subject from one video source, such as footage being captured by a video camera, is inserted into the footage from another video source, such as a movie on a DVD. This mixing by the chroma-key mixer 418 may be accomplished, in certain embodiments, in real time.

In certain embodiments, the chroma-key mixer 418 produces a composite image by subtracting a chroma element or elements from the real-time image, such as from a video recorder. The chroma element comprises at least one color that has been pre-selected or that is selected by the user and is used in the background for the video-recorded image. Upon receiving the real-time signal, the chroma-key mixer 418 removes the chroma element (the background) from the video recorded image, thereby leaving only the image of the target subject.

For example, in so-called “green screening,” a target subject is positioned in front of a green screen. The image of the target subject is then captured by a video recorder and transmitted as a signal to the chroma-key mixer 418. The chroma-key mixer 418 subtracts the chroma element (green) from the video recorder signal, leaving the image of the target subject along with “blank” portions where the real-time image had contained the chroma element. The chroma-key mixer 418 then replaces the subtracted, or blank, portions of the real-time image with portions of the image contained by the signal from the multiplexer 416, such as scenes from a movie on a DVD. As a result of the signal processing, it appears to a viewer that the target subject image, which is a real-time image, is present in a movie or other prerecorded video. The resulting composite image is made up of at least two video components: a foreground image, which consists of the non-chroma element portions of the video recorder signal, and a background image, which consists of the signal received from the multiplexer 416.

Though this example describes the functioning of one embodiment of the chroma-key mixer 418, other processes may be used to produce a composite signal. For example, the chroma-key mixer 418 may directly substitute portions of the video source signal for the chroma-element portions of the real-time video signal. In another embodiment of the invention, the chroma-element portions of the real-time video signal are made transparent by the chroma-key mixer 418. This allows the non-chroma element portions of the real-time video signal to be layered on top of the video source signal to create the composite image.

Furthermore, the chroma element may be colors other than green. For example, blue or red may be designated as the chroma element. In addition, multiple shades of the same color may be identified as chroma elements, allowing for a finer tuning of the composite image by the chroma-key mixer 418. For example, in certain embodiments of the invention, the user may select portions (or colors) of the real-time image that the user wishes to remove or make transparent by designating the colors as chroma elements.

The chroma-key mixer 418 may perform the above-described compositing process through various techniques. For example, in one embodiment of the invention, the chroma-key mixer 418 utilizes digital processing to create the composite image. In other embodiments, the chroma-key mixer 418 may create the composite image through optical techniques or through the use of analog real-time circuits that are known in the art. In yet other embodiments, the chroma-key mixer 418 comprises a luminance key mixer, which performs video compositing based on the brightness of portions of an image instead of color.

In yet other embodiments of the invention, the above-described video compositing process is performed without a screen for the video recorder image. For instance, the chroma-key mixer 418 may filter out portions of a video image based on the color and/or brightness of a target subject instead of a screen. In other embodiments, the compositor device 402 may utilize a mixer that is capable of filtering out portions of an image based on the motion of the target subject or a position of the target subject in relation to the subject's background. For example, the video recorder may be used to focus on a target subject that is a certain distance from the video recorder, and the mixer may filter out portions of a captured image that are not in focus.

As shown, the chroma-key mixer 418 outputs the composite signal to the switcher 420. The switcher 420 also receives the output signal of the multiplexer 416. In certain embodiments, the switcher 420 selects between the signal from the multiplexer 416 and the composite signal from the chroma-key mixer 418 based on communications with the control circuitry 410. In particular, the operation of the switcher 420 may be directed by the control circuitry 410 based on information contained in the data files, such as reference information regarding beginning and ending reference points.

In certain embodiments, the control circuitry 410 cross-references each frame of a prerecorded video with the beginning and ending reference points contained in the data files corresponding to the specific video being played. When the DVD counter, whose value relates to the specific frame being played, matches or correlates with a beginning reference point value, the switcher 420 selects the composite signal from the chroma-key mixer. As a result, a target image being captured by the video recorder is “inserted” or superimposed in the prerecorded video scene. When the DVD counter matches or correlates with an ending reference point, the switcher 420 selects the signal from the multiplexer 416, thus removing the image of the target subject from the prerecorded video scene.

For example, suppose a user wants to insert himself or herself for Darth Vader® in a video clip from Star Wars, which is being played by the DVD player 414. First, the data files for the movie Star Wars that contain information relating to the video footage of Darth Vader® are accessed by the control circuitry 410 such as from a data portion of a DVD or from the memory 412. During frames not containing video footage of Darth Vader®, the signal from the multiplexer 416 (which comes from the DVD player 414) is selected by the switcher 420. Viewers of the display see the normal footage from the Star Wars movie.

The signal from the multiplexer 416 is selected by the switcher 420 until the control circuitry 410 instructs the switcher 420 to select the composite signal from the chroma-key mixer 418. This switching to the composite signal occurs when video footage of Darth Vader® is contained in the video source signal. In certain embodiments, the control circuitry 410 identifies the footage containing Darth Vader® by cross-referencing the relevant beginning and ending reference points from the data files. The beginning reference points identify the points or times in the movie when Darth Vader® enters a scene. As a result, when a beginning reference point matches or correlates with the DVD counter, which identifies a particular point of time or frame in the movie, the control circuitry 410 instructs the switcher 420 to select as an output the composite signal from the chroma-key mixer 418. Instead of seeing Darth Vader® on the display, viewers see in his place the real-time image of the target subject, which is being captured by the video recorder.

The ending reference points identify the points or times when Darth Vader® leaves a movie scene. When an ending reference point matches or correlates with the DVD counter, the control circuitry 410 then instructs the switcher 420 to select as an output the signal from the multiplexer 416. As a result, the target image from the video recorder is not shown on the display.

The reference information, therefore, is used in certain embodiments to automatically control the switching process between the signal from the video source and the composite signal from the chroma-key mixer 418. For example, the reference information may comprise beginning and ending reference points that correspond to the presence of a particular character in a movie or that indicate other points when it would be desirable to superimpose a real-time target image on a prerecorded image. The reference information of the data files may also be used to manage the audio components of the signals received from the multiplexer 416 and the video recorder. For example, in certain embodiments, the control circuitry 410 instructs the switcher 420 to: (1) include only the audio component of the signal from the multiplexer 416 in the output signal, (2) include only the audio component of the signal from the video recorder in the output signal, or (3) include both the audio components of the signals from the multiplexer 416 and the video recorder in the output signal.

In certain embodiments, the reference information is also used to manage the display of voice prompts. For example, the reference information may indicate when to show voice prompts for a particular character. In such an embodiment of the invention, the reference information corresponding to voice prompts may be located in the same data file as, or in a separate data file from, the reference information corresponding to video or audio components of the video source.

Although, the terms “beginning reference points” and “ending reference points” are used herein to describe the functioning of a compositing process, the beginning and ending reference points may be structurally and functionally equivalent. For example, in certain embodiments, reference points stored in the data files are not identified as “beginning” or “ending” reference points and may be used by the control circuitry 410 to output a signal that causes the switcher 420 to change its state irrespective of what state the switcher was operating in previously.

With continued reference to FIG. 4, the compositor device 402 comprises the user interface 422 which accepts input from and/or conveys information to a user. In certain embodiments, the user interface 422 is coupled to the chroma-key mixer 418 and to the control circuitry 410. In other embodiments, the user interface 422 may be coupled to more or fewer components of the compositor device 402. For example, the user interface may be directly coupled to the DVD player 414 to control the operation of the DVD player without the use of the control circuitry 410.

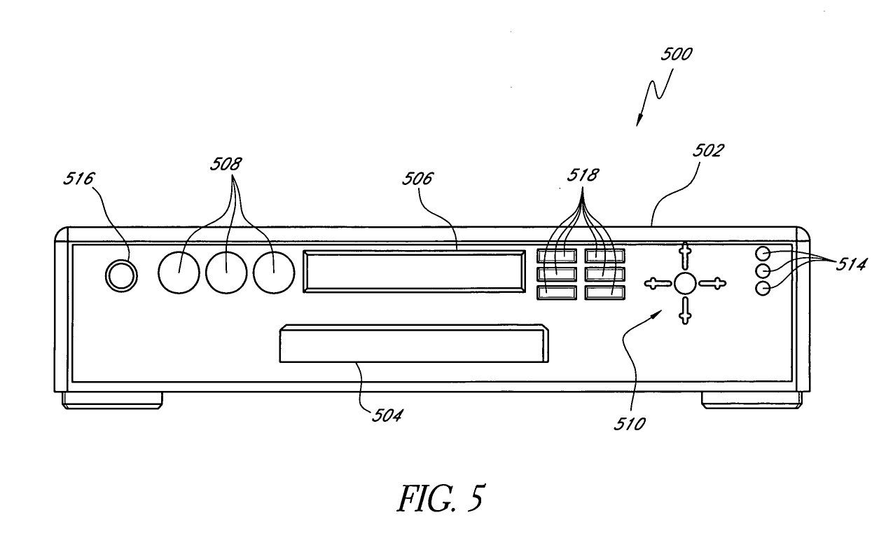

An exemplary embodiment of a user interface 502 is illustrated in FIG. 5. The user interface 502 comprises a front tray portion of a DVD player 504, a display 506, editing controls 508, cropping/chroma controls 510 and a camera input display 514. In other embodiments of the invention, the user interface 502 may comprise more or fewer components. For example, the user interface 502 may operate without the display 506 or without the editing controls 508.

The display 506 conveys to the user information regarding the operation of the compositor device. For example, the display 506 may depict information regarding the tracks of an inserted DVD, the chroma color selections, the data files (such as the film title or the tracks/scenes available for substitution) or other like information. In one embodiment, the display 506 is a light emitting diode (LED) display. In other embodiments, the display 506 is a liquid crystal display (LCD).

The cropping/chroma controls 510 allow a user to modify in real time the video image being captured by the video recorder so that the image conforms to the prerecorded video scene. In certain embodiment, the cropping/chroma controls 510 allow the user to select the chroma element or elements to be subtracted from the captured video image. Such a selection may be made by choosing the name of a particular color or by choosing a visual representation of the color that is shown on the user interface display 506 or the external display.

The cropping/chroma controls 510 also allow the user to crop the captured video image to appropriately size the image for the prerecorded background image. These controls may be used to zoom out or zoom in on a target subject in order to adjust the size of the target subject to be in proportion with other objects in the prerecorded scene on to which the target subject is superimposed.

Other embodiments of the invention may contain other controls for modifying the captured video. For example, the user interface 502 may comprise a color saturation control that adjusts the color level of the captured video. This allows for a color image to be adjusted to blend in with a black and white background or similar background.

The optional camera input display 514 identifies the video recorders that are connected to the compositor device and that are available to capture video for processing. For example, if multiple video recorders were coupled to the compositor device, then multiple lights of the camera input display 514 may be illuminated. In other embodiments of the invention, the camera input display 514 identifies when the video being captured by one of the video recorders is being processed and output to the display.

In certain embodiments, the user interface 502 also comprises controls that are generally found on CD/DVD players. For example, the user interface 502 comprises a power button 516 and DVD/CD controls 518, such as play, rewind, fast forward, stop, pause, eject and the like, that are used to control the operation of the DVD player 504.

In certain embodiments, the user interface 502 also includes a remote control input (not shown). The remote control input may accept instructions or data transmitted to the user interface 502 from one or more remote control devices. These instructions may correspond to controls that are present on the user interface 502 or may include more or fewer instructions that enable the user to manage the operation of the compositor device.

Though FIG. 5 depicts one implementation of the user interface 502, other types of user interfaces may be used. For example, the user interface 502 may comprise a touch screen that both displays information to a user and accepts input from the user. In other embodiments, the user interface 502 may accept instructions through voice recognition or may be coupled to another system or device, such as a keyboard or personal computer, that accepts input from a user. In yet other embodiments, the compositor device operates without a user interface 502. In such embodiments, a user interface may be incorporated into the display.

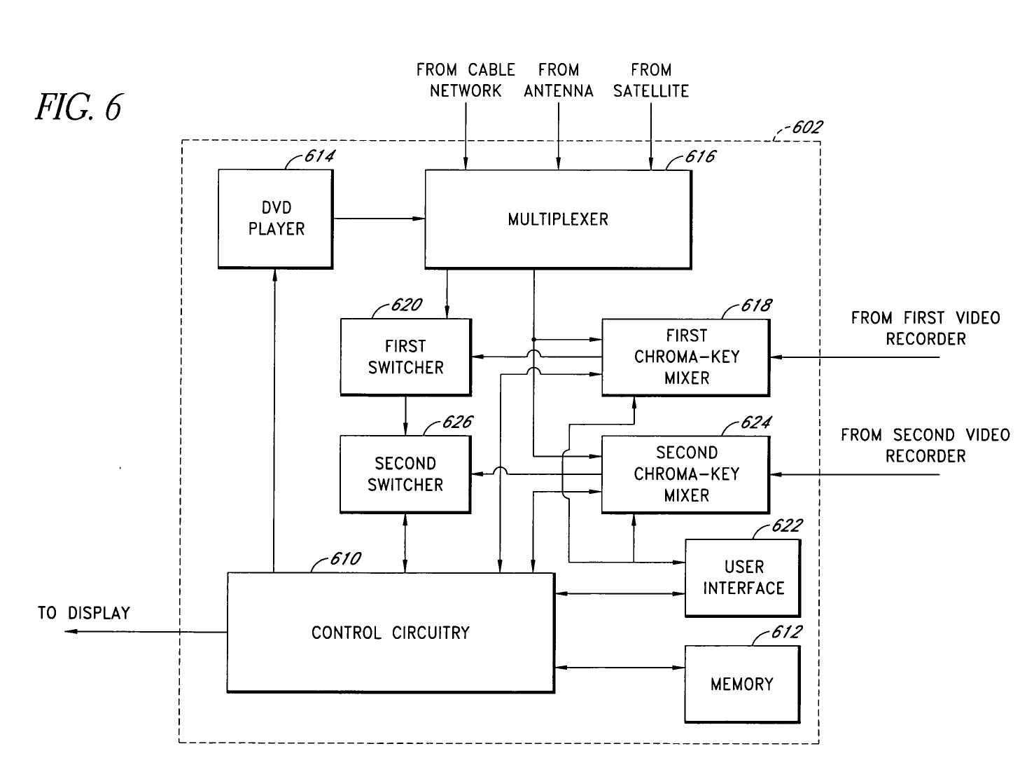

FIG. 6 is a block diagram of an embodiment of the invention wherein a compositor device 602 is structured to receive input from multiple video recorders. As can be seen in FIG. 6, the compositor device 602 includes similar components to the compositor device 402 depicted in FIG. 4 (i.e., control circuitry 610, a memory 612, a DVD player 614, a multiplexer 616, a first chroma-key mixer 618, a first switcher 620, and a user interface 622). The compositor device 602 of FIG. 6 additionally comprises a second chroma-key mixer 624 and a second switcher 626.

In one embodiment, the second chroma-key mixer 624 functions similarly to the first chroma-key mixer 618. In particular, the second chroma-key mixer 624 receives signals from the multiplexer 616, the first chroma-key mixer 618 and a second video recorder. The second chroma-key mixer 624 may also receive instructions from the control circuitry 610. Like the first chroma-key mixer 618, the second chroma-key mixer 624 removes the chroma element from a real-time image, such as captured by the second video recorder, and combines the modified real-time image with another signal to form a composite signal. In an embodiment having two video recorders, the second chroma-key mixer 624 may combine the real-time image captured by the second video recorder with either the prerecorded video from the multiplexer 616 or the composite signal outputted by the first chroma-key mixer 618. The second chroma-key mixer 624 then outputs a second composite signal to the second switcher 626.

In other embodiments, the second chroma-key mixer 624 may be external to the compositor device 602. In yet other embodiments, portions of the second chroma-key mixer 624 may be external to the compositor device 602 and portions of the second chroma-key mixer 624 may be internal to the compositor device 602.

The second switcher 626 functions similarly to the first switcher 620. In certain embodiments, the second switcher 626 receives signals from the first switcher 620 and from the second chroma-key mixer 624. The second switcher 626 selects between these inputs based upon instructions received from the control circuitry 610. The second switcher 626 may output a signal to the control circuitry 610 or to the display. In one embodiment of the invention, the content of the output signal of the second switcher 626 may include: (1) the prerecorded signal from the multiplexer 616, (2) the composite signal from the first chroma-key mixer 618 having portions of an image from the first video recorder, (3) the second composite signal from the second chroma-key mixer 624 having portions of an image from the second video recorder, or (4) the second composite signal from the second chroma-key mixer 624 having portions of images from the first video recorder and from the second video recorder.

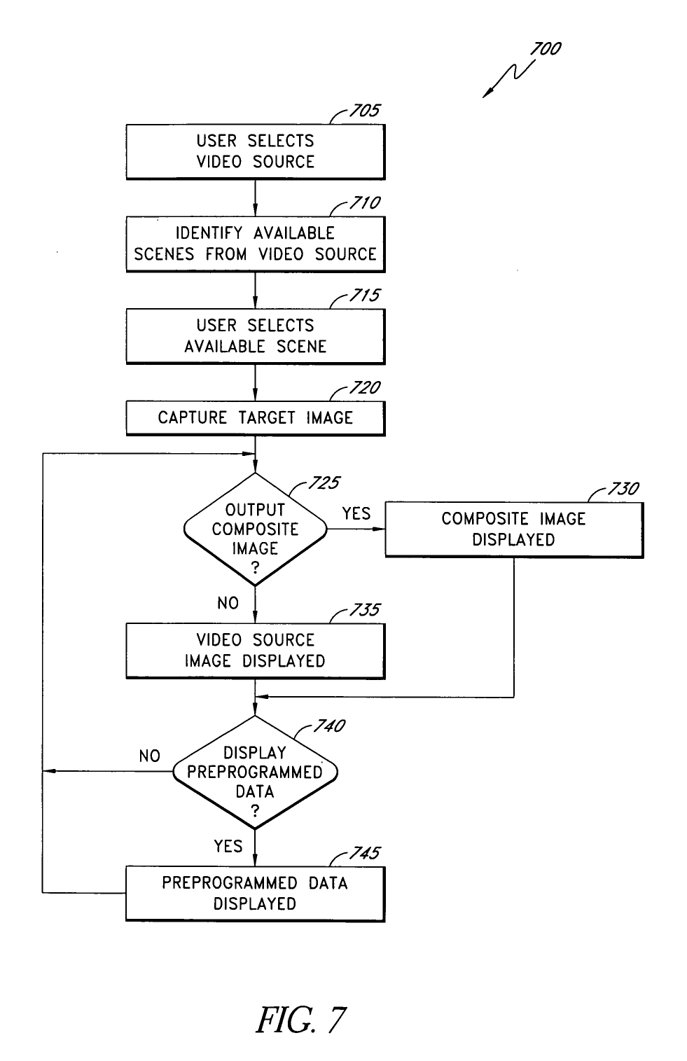

The operation of one embodiment of a video compositing system will now be described. FIG. 7 illustrates one embodiment of an interactive video compositing process 700. For exemplary purposes, the compositing process 700 will be described with reference to the components of the compositor device of FIG. 4.

The compositing process 700 begins with Block 705 wherein a user selects a video source to use as a background image for a final composite image. For example, the user may insert a favorite movie into the DVD player 414. After the user has selected a particular video source, the data files associated with the video source are accessed by the compositor device 402 to identify scenes recorded on the DVD that have been catalogued as being suitable for chroma key substitution (Block 710). In certain embodiments of the invention, the suitable scenes are identified by the data files stored on a data portion of a DVD+M disc or are stored in the memory 412 of the compositor device 402. In certain embodiments, the data files comprise reference information that identifies which scenes of the DVD contain video footage of a particular movie character.

The available scenes are communicated to the user, such as through the user interface or external display. At Block 715, the user selects an available scene into which the user wants to superimpose or “insert” a real-time image.

After the user selects an available scene, the compositing process 700 proceeds with Block 720. At Block 720, a video recorder is used to capture a target image to be used to overlay, or be inserted into, in real time, the scenes from the video source. For example, the target image may be positioned in front of an evenly lit, colored background, which color represents the chroma element. For instance, in an embodiment wherein the selected chroma element is green, the target image is positioned in front of a “green screen.” Of course, other colors or types of backgrounds may be used that enable the background to be later “removed” when forming a composite image with scenes from the video source. In yet other embodiments, no screen is used for the compositing process 700. The chroma-key mixer 418 of the compositor device 402 then creates a composite image through processes that have been previously discussed.

The compositing process 700 then moves to Block 725. At Block 725, it is determined whether the video source image or the composite image is to be selected as the output image. In certain embodiments, this selection of the output image is made by the switcher 420. The control of this selection may be performed automatically (without user interaction) by the compositor device 402 using information from the prerecorded data files, or the user may control the operation of the switcher 420 through the user interface 422. For example, the control circuitry 410, based in the beginning and ending reference points contained in the data files, may instruct the switcher 420 when to output the video source image and when to output the composite image that has the target image overlaid on the video source image.

If at Block 725, the switcher 420 is instructed to select the composite image, the compositing process 700 moves to Block 730. At Block 730, the composite image is shown on the display. Viewers of the display will observe the real-time target image inserted into the prerecorded footage from the video source. For example, viewers may see the target image replacing a character in a movie playing on the DVD player 414.

If at Block 725, the switcher 420 is instructed to select the video source image, the compositing process 700 moves to Block 735. At Block 735, the image from the video source is shown on the display. After Block 735, the compositing process 700 then proceeds to Block 740.

At Block 740, it is determined whether or not preprogrammed data is to be displayed instead of the video source image or the composite image. Such preprogrammed data may include, for example, prerecorded scenes that are stored in the memory 412. In one embodiment, the prerecorded scenes comprise video clips that users may want to insert to make the displayed scenes appear more interactive or to appear more life-like. For example, prerecorded video clips having various forms of feedback from judges may be inserted after a target subject has acted out a scene (which was observed by the viewers of the display). In one embodiment, different video clips are selected to be displayed based on input given by the viewers.

If preprogrammed data is to be displayed, the compositing process 700 moves to Block 745 wherein the preprogrammed data is communicated to the display. In certain embodiments, the control circuitry 410 directs which signal is communicated to the display. In another embodiment, a multiplexer or other similar device may be used to select which signal is output to the display. The length of time that the preprogrammed data is displayed may be directly controlled by the user or may be for a set length of time. Upon completion of Block 745, the compositing process 700 returns to Block 740. If preprogrammed data is not to be displayed, the compositing process 700 returns to Block 725 to determine whether the video source image or the composite image is to be displayed.

The compositing process 700 illustrated in FIG. 7 is only one example of the functioning of the compositor device 402. For example, in other embodiments of the invention, additional blocks may be added that illustrate the separate control of audio signals and video signals. In other embodiments, preprogrammed data may be displayed at the beginning of the compositing process 700 or upon the selection of a particular video source for playback.

The compositor device 402 may be particularly useful with preprogrammed video that is easily adapted to allow for user interaction. For example, to help further illustrate an embodiment of the compositing process 700, assume that the user selects a DVD+M that includes recorded scenes from the television talent show American Idol. Data files corresponding to video segments on the media portion of the DVD+M are stored on the data portion of the DVD+M. Upon insertion of the DVD+M, the user is provided with options of scenes that are available for user interaction. For example, the user may have the option to select different scenes in which the user may “perform” in front of the judges or an audience.

Through the user interface 422, the user selects a scene for video compositing. For example, the user may pick a scene in which a contestant is performing by signing a song in front of the judges. The user whose image is to be substituted into the American Idol footage is positioned in front of the video recorder. The individual then performs as if he or she was actually participating on the American Idol program, the performance of the individual being captured by the video recorder and converted to a signal communicated to the compositor device 402.

The display shows video and audio from the American Idol program. During the American Idol scenes that would normally contain recorded footage of the participant on the actual program, the real-time image of the individual being captured by the video recorder is substituted for the participant. As a result, it appears to viewers of the display that the individual is actually participating on the American Idol program. The timing of the substitution of images is determined by the reference information recorded in the data files.

Audio signals that are captured by the video recorder are also output through the display. Like the video images, the substitution of the real-time audio signals from the video recorded footage may occur at appropriate points in the American Idol scenes, such as when the participant is performing or singing. The audio substitution need not occur at the same times as the video substitution. For example, there may exist portions of the American Idol footage that contain the voice of the participant but that do not contain the video image of the participant. Again, the substitution of the audio signals may be automatically controlled by the compositor device 402 based on the data file information and/or may be manually controlled by the user.

After the performance, viewers have the option to rate the performance of the individual who has been inserted into the program. These viewer ratings may then be used to select the display of prerecorded video clips having feedback from the judges on American Idol. For example, prerecorded video clips of good reviews, bad reviews, and average reviews may be stored on the DVD+M or in the memory 412 of the compositor device 402. The viewers then have the option of inputting their opinions of the performance, such as through remote controls communicating with the user interface 422. If the viewers rate the performance by the individual as being generally poor, then the compositor device 402 selects the playback of video clips that include the judges being critical of the performance. On the other hand, if the users rate the performance as being generally good, then the compositor device 402 selects the playback of video clips that give positive feedback from the judges.

In other embodiments of the invention, the above-described American Idol program may be stored entirely in the memory 412 of the compositor device 402 without the use of a DVD. In yet other embodiments, the compositor device 402 may include a monitor that displays the appropriate voice prompts to the user.

Although embodiments described herein have related generally to real-time video compositing with sources such as movies, television programs and the like, other embodiments of the invention may utilize any source of video, audio, or a combination thereof. For example, in another embodiment of the invention, the compositor device may accept video or audio input from a video game system. Such would allow a user to “insert” himself or herself into the video game and to interact with objects therein.

It is contemplated that the DVD+M is usable both on video compositing devices, such as those described herein, and general-purpose DVD players. For example, when the DVD+M is inserted into a general purpose DVD player, the DVD player outputs the stored media (i.e., video and audio) without utilizing the stored reference information to perform video compositing.

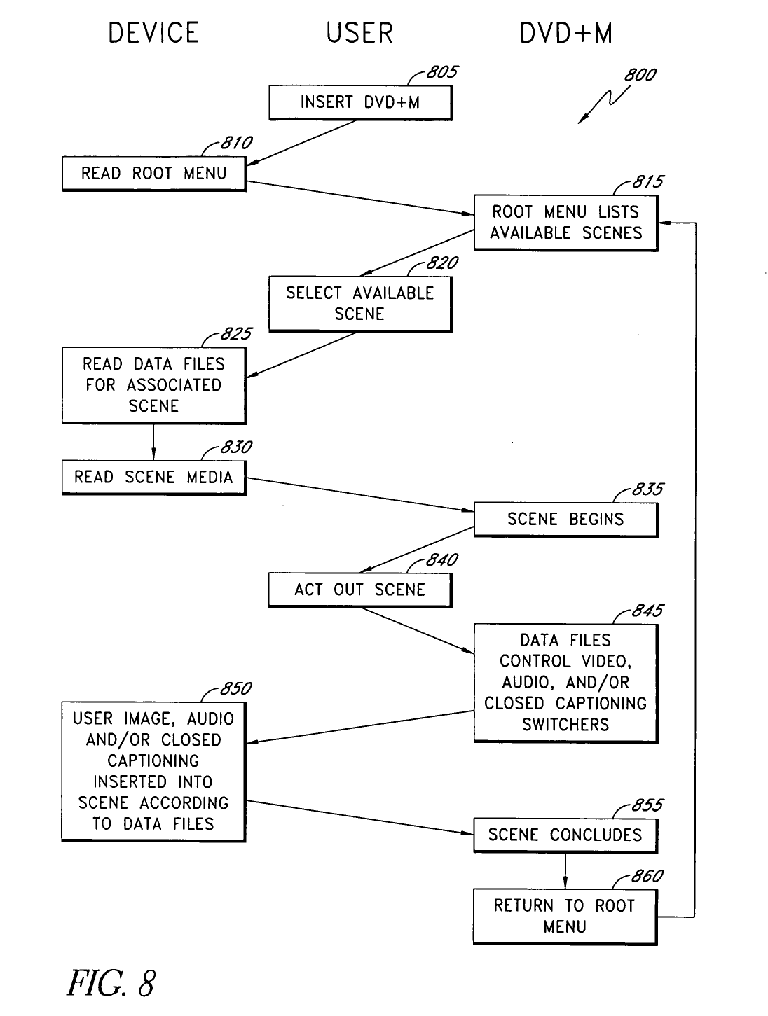

FIG. 8 illustrates a flowchart depicting an exemplary embodiment of an interactive process 800 that includes an interplay between a user, a DVD+M and a device capable of reading and playing the DVD+M. For example, the device of the interactive process 800 may include either of the compositor devices 402, 602 of FIGS. 4 and 6, respectively. In certain embodiments, the device preferably couples to or includes a display, such as a screen, for portraying unmodified and/or composite video scenes to the user.

The interactive process 800 begins at Block 805, wherein the user inserts the DVD+M into the device. At Block 805, the device reads the root menu of the DVD+M. In certain embodiments, the root menu may comprise a read-only portion of the DVD+M that is automatically read by the device when the DVD+M is first loaded into the device.

At Block 815, the root menu of the DVD+M lists the user selectable scenes that are stored on the DVD+M and that are available to the user for video compositing. Once one or more scenes are presented to the user, such as through a display of the device, the user selects an available scene for interactive video compositing. In certain embodiments, the user is able to select a particular character for which he or she would like to be substituted during the particular scene.

After the user selection of the scene, the device reads the data files for the selected scene, which is shown by Block 825. In certain embodiments, the data files include information regarding: the starting and stopping points of the scene and/or characters in the scene; audio information for the scene and/or characters in the scene; the brightness, hue, color, and/or contrast of the scene; combinations of the same or the like.

At Block 830, the device reads the scene from the DVD+M, and Block 835, the scene begins playing and is preferably visible to the user. At Block 840, the user acts out the particular character and/or portion of the scene. For example, as described above, the user may act out the scene in front of a green screen or using screenless technologies.

At Block 845, as the user acts out the scene, the data files stored on the DVD+M indicate when the user image and associated audio are to be inserted into the scene. In addition, the data files may provide information regarding closed captioning signals to be displayed, which may provide the user with voice prompts for the particular portion of the scene. At Block 850, the device inserts the user image and/or audio into the appropriate portions of the scene as indicated by the data files.

Once the scene concludes, either automatically or by a user selection, which is illustrated by Block 855, the interactive process 800 returns to the root menu of the DVD+M, as shown by Block 860. The user may then choose another scene for interactive video compositing.

Although the foregoing has been described in terms of certain preferred embodiments, other embodiments will be apparent to the skilled artisan from the disclosure herein. In addition, while certain embodiments have been described, these embodiments have been presented by way of example only, and do not limit the scope of the disclosure. Indeed, the novel methods and systems described herein may be embodied in a variety of other forms, and various omissions, substitutions and changes in the form of the methods and systems described herein may be made without departing from the spirit of the disclosure.

What is claimed is:

1. A storage medium for use in interactive video compositing, the storage medium comprising:
a first portion including media data usable to produce at least one video image having multiple frames; and
a second portion including reference data associated with the media data and further comprising first video reference data and second video reference data, wherein the first video reference data identifies a first frame of the at least one video image to be combined with a second video image to form a composite video image to be communicated to a display, and wherein the second video reference data identifies a second frame of the at least one video image to be communicated to the display.

2. The storage medium of claim 1, wherein the first portion and the second portion are recorded on a digital versatile disc (DVD).

3. The storage medium of claim 2, wherein the first portion and the second portion are recorded on different layers of the DVD.

4. The storage medium of claim 1, wherein the at least one video image comprises a movie.

5. The storage medium of claim 4, wherein the first frame corresponds to when a character enters a scene of the movie, and wherein the second frame corresponds to when the character has exited the scene of the movie.

6. The storage medium of claim 1, wherein the reference data identifies frame numbers of the at least one video image.

7. The storage medium of claim 1, wherein the reference data identifies time codes associated with the at least one video image.

8. The storage medium of claim 1, wherein the reference data further comprises audio reference data that identifies an audio portion, associated with the at least one video image, to be replaced by a real-time audio signal.

9. A method for video compositing, the method comprising:
receiving from a prerecorded medium a first video signal having multiple frames;
receiving a second video signal;
creating a composite signal by mixing the first video signal and the second video signal; and
selectively switching between outputting the first video signal and outputting the composite signal, wherein said selective switching is performed automatically and is based at least in part on reference data, stored on the prerecorded medium, that corresponds to frames of the first video signal.

10. The method of claim 9, wherein the second video signal is a real-time video signal.

11. The method of claim 10, further comprising receiving the second video signal from a video recorder.

12. The method of claim 10, wherein said selectively switching is performed in real time with respect to the second video signal.

13. The method of claim 9, wherein the prerecorded medium is a digital versatile disc (DVD).

14. The method of claim 9, wherein said selectively switching includes communicating one of the first video signal and the composite signal to a display.

15. A system for real-time video compositing, the system comprising:
a reader configured to obtain from a storage medium a first video signal and at least one data file associated with the first video signal, the at least one data file having at least first reference data and second reference data;
a video input configured to receive a second video signal;
a mixing module coupled to the reader and to the video input, wherein the mixing module is configured to output a composite signal comprising portions of the first video signal and portions of the second video signal; and
a switching module that selects between outputting the composite signal and outputting the first video signal, wherein the switching module outputs the composite signal at a time identified by the first reference data and outputs the first video signal at a time identified by the second reference data.

16. The system of claim 15, wherein the storage medium comprises a removable memory.

17. The system of claim 16, wherein the storage medium is a digital versatile disc (DVD).

18. The system of claim 15, wherein at least one of the mixing module and the switching module is implemented at least in part as a set of software instructions.

19. An electronic system for performing video compositing, the electronic system comprising:
means for receiving from a single storage medium a first video signal and at least one data file associated with the first video signal, the at least one data file including first reference data and second reference data;
means for receiving a second real-time video signal;
means outputting a composite signal comprising portions of the first video signal and portions of the second real-time video signal; and
means for selectively switching between outputting the composite signal and outputting the first video signal, wherein said means for selectively switching automatically outputs the composite signal at a time identified by the first reference data and automatically outputs the first video signal at a time identified by the second reference data.

20. The electronic system of claim 19, wherein the single storage medium is a digital versatile disc (DVD).
